(19) United States
(12) Patent Application Publication
(10) Pub. No.: US 2023/0292803 A1
(43) Pub. Date: Sep. 21, 2023

(54) SWEETENER COMPOSITION AND RESULTANT BEVERAGE PRODUCT

(71) Applicant: Premier Nutrition Company, LLC, Emeryville, CA (US)

(72) Inventors: Liqiang Zhao, Emeryville, CA (US); Madhavi Ummadi, Emeryville, CA (US)

(21) Appl. No.: 18/157,635

(22) Filed: Jan. 20, 2023

Related U.S. Application Data
(60) Provisional application No. 63/301,777, filed on Jan. 21, 2022.

(51) Int. Cl. A23L 27/30

(52) U.S. Cl. CPC A23L 27/34; A23L 27/31

(57) ABSTRACT

Described herein is a sweetener composition useful for improving the taste and mouthfeel of food and beverage composition as well as a ready to drink or ready to mix beverage composition, such as a protein shake comprising the sweetener composition.

### CROSS-REFERENCE TO RELATED APPLICATIONS

This application claims the benefit of the U.S. Provisional Application Serial Number 63/301,777, entitled “Sweetener Composition and Resultant Beverage Product,” filed Jan. 21, 2022, the contents of which are incorporated by reference herein, for all purposes, in its entirety.

### FIELD OF THE DISCLOSURE

The present disclosure generally relates to a sweetener composition that when incorporated into food and beverage products provides improved consumer satisfaction for taste, flavor profile and mouthfeel than other sweeteners, as well as the resultant beverage composition, such as a protein shake, comprising the sweetener composition. Accordingly, the present disclosure involves the fields of food science, sensory and consumer science, chemistry, and rheology.

### BACKGROUND

Many compounds have been identified that are capable of sweetening consumer food or beverage compositions. These sweeteners can be used alone or in combination with beverages, baked goods, deserts, and snacks. Sweeteners used in everyday life can be natural or artificial sweeteners.

The use of natural caloric sweetener compositions has a taste that most consumers desire but are high in caloric content. Alternatively, artificial sweeteners which are typically non-caloric or low-caloric sweeteners are widely used as sugar substitutes, but these can be expensive, exhibit tastes or flavors that are different or off-tasting for consumers with flavor profiles and mouthfeel that are not similar enough for consumers compared to sugar or other natural sweeteners. Additionally, consumers desire ingredients that are “natural” and allow food and beverage manufacturers to create a label that is seen as using “clean” or “natural” compositions.

A significant market exists for reduced calorie foods and beverages. There is thus a need in the art for a sweetener composition that can enhance or increasing the perception of sweetness of a food or beverage composition. The desired sweetener composition will include a re-balancing of the flavor and taste compositions to create a taste profile or sweetness enhanced compositions without off-taste or lingering undesirable after-taste and furthermore, exhibits good mouthfeel or temporal profiles. The desired sweetener composition further improves the taste and sensory attributes of the resultant beverage or food composition without adverse effects on the beverage or food composition. The beverages can include RTD (ready-to-drink), such as packaged beverages including shelf stable liquid beverages ready for consumption and RTM (ready-to-mix), such as powders or other dry mix compositions.

### SUMMARY OF THE DISCLOSURE

Generally, the invention disclosed herein is a sweetener composition having enhanced sweetness with an improved flavor profile and/or temporal profile (such as physical attributes including mouthfeel). The invention further includes a method for improving the flavor or temporal profile of a sweetener compositions and a method for improving the flavor or temporal profile of a beverage composition that includes the sweetener composition. The sweetener composition provides a heightened sweetness and a taste similar to real sugar that is desired by consumers. Also, when used in food and beverage products the products also exhibit a taste and temporal profile similar to products that use real sugar. Food and beverage products that include the sweetener composition exhibit distinct rheological properties compared to current products that use current sweetener compositions. The rheological properties of the products using the novel sweetener composition are not disrupted by the sweetener composition.

The invention disclosed herein is a sweetener composition having an enhanced sweetness with an improved flavor profile and temporal profile comprising at least one natural sweetener, at least one artificial sweetener, a mask agent, a protein binder and a mouthfeel modulator. The ingredients work in synergy to create a unique sweetener composition that imparts a unique and desirable flavor and temporal characteristic sought by consumers. The unique combination demonstrates improved characteristics in products that use the sweetener composition.

Also disclosed, the present invention relates to a beverage or food composition comprising the sweetener composition, wherein the sweetener composition comprises at least one natural sweetener, at least one artificial sweetener, a masking agent, a protein binder, and a mouthfeel modulator. The present invention further relates to a method for making a reduced calorie beverage or food compositions by adding the sweetener composition of the present invention to the beverage or food composition.

### BRIEF DESCRIPTION OF THE FIGURES

The patent or application file contains at least one drawing executed in color. Copies of this patent or patent application publication with color drawing(s) will be provided by the Office upon request and payment of the necessary fee.

The application file contains at least one drawing executed in color. All requested color drawings will be provided upon request.

FIG. 1 is a table that demonstrates a graphical representation comparing consumer sensory testing of beverage compositions that use the current inventive sweetener composition compared to current consumer beverage products.

FIG. 2 is a table that demonstrates a graphical representation comparing consumer sensory testing of beverage compositions that use the current inventive sweetener composition compared to current consumer beverage products.

FIGS. 3a and 3b overview of the composition of an RTD (ready-to-drink) and RTM (ready-to-mix) Protein Shake and method of production.

FIG. 4. is a graph that demonstrates the rheology characteristics of the beverage compositions that use the current inventive sweetener composition compared to current consumer beverage products.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described to avoid obscuring the description.

Concentrations, amounts, and other numerical data may be expressed or presented herein in a range format. It is to be understood that such a range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 2 to about 50” should be interpreted to include not only the explicitly recited values of 2 to 50, but also include all individual values and sub-ranges within the indicated range. Thus, included in this numerical range are individual values such as 2, 2.4, 3, 3.7, 4, 5.5, 10, 10.1, 14, 15, 15.98, 20, 20.13, 23, 25.06, 30, 35.1, 38.0, 40, 44, 44.6, 45, 48, and sub-ranges such as from 1-3, from 2-4, from 5-10, from 5-20, from 5-25, from 5-30, from 5-35, from 5-40, from 5-50, from 2-10, from 2-20, from 2-30, from 2-40, from 2-50, etc. This same principle applies to ranges reciting only one numerical value as a minimum or a maximum. Furthermore, such an interpretation should apply regardless of the breadth of the range or the characteristics being described.

Several definitions that apply throughout this disclosure will now be presented. Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

As used herein, the terms “comprising,” “having,” and “including” are used in their open, non-limiting sense. The terms “a,” “an,” and “the” are understood to encompass the plural as well as the singular. Thus, the term “a mixture thereof” also relates to “mixtures thereof.”

As used herein, “about” refers to numeric values, including whole numbers, fractions, percentages, etc., whether or not explicitly indicated. The term “about” generally refers to a range of numerical values, for instance, ± 0.5-1 %, ± 1-5% or ± 5-10% of the recited value, that one would consider equivalent to the recited value, for example, having the same function or result.

As used herein flavor profile is to a method of judging flavor or foods or beverages by examination of a list of separate factors into which flavor can be analyzed, include the so-called character notes of the product.

As used herein temporal profile is the sensory perception of foods. This includes mouthfeel and other sensory characteristics created during the consumption of food or beverages. The mouthfeel is a sensation that a person experiences inside the mouth while eating or drinking. It is a fundamental sensory attribute which, along with taste and smell determine the overall flavor of a food or beverage item.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various embodiments given in this specification.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

### I. Sweetener Composition

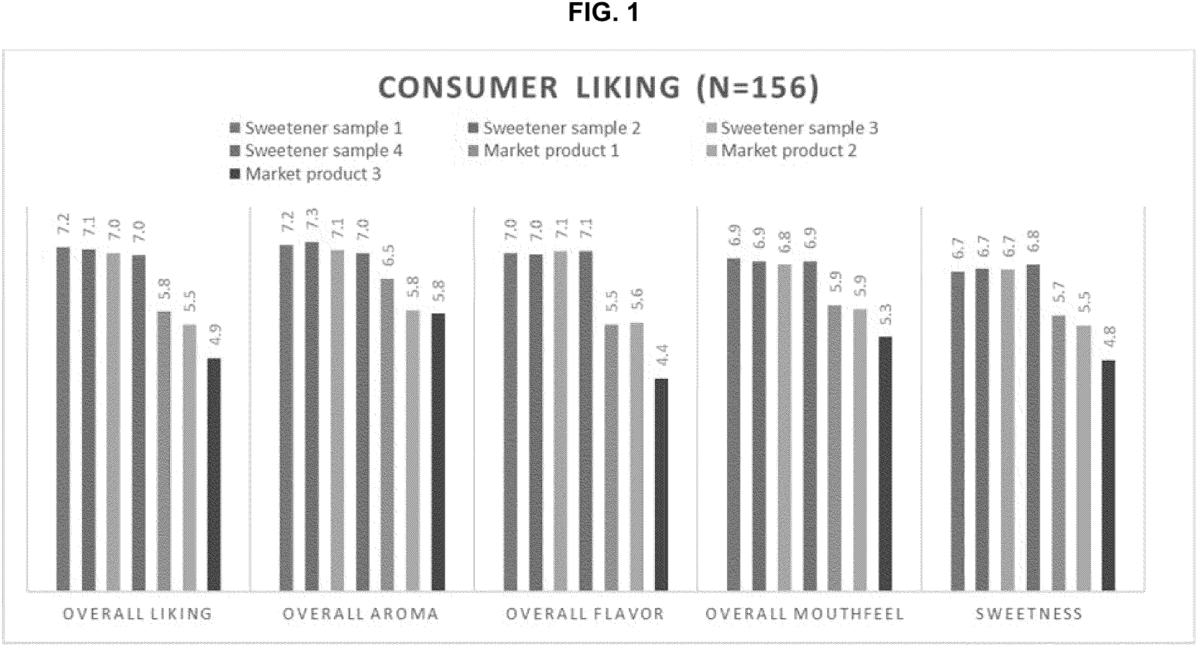

Disclosed herein is a sweetener composition with enhanced sweetness and improved flavor and temporal profiles. The sweetener composition is useful for improving the taste and mouthfeel of a beverage, including protein shakes. The improved taste, including a more desired sweetness profile and mouthfeel (temporal profiles) imparted by the sweetener composition is demonstrated by the sensory and rheological properties of the beverage with the sweetener composition. See FIGS. 1, 2, and 4. In some embodiments, the sweetener composition may be used in a liquid beverage, semi solid or solid beverage composition, such as a low acid and high acid shakes, teas, coffee, soft drinks, fruit juices and flavored waters, CO₂ infused beverages with or without carbonation, or in a semisolid food composition, such as a yogurt or ice cream. The sweetener composition may be used in other products such as but not limited to protein powders, baking mixes, cereals, grain breads, snack bars, and other various consumer products. In some embodiments, the sweetener composition may include at least one natural sweetener, at least one artificial sweetener, a mask agent, a protein binder, and a mouthfeel modulator. The sweetener composition may have a concentration in the beverage or ready to make powder compositions to create the beverage (such as protein shakes/powders to make beverages) of about 0.02% up to 0.29%. In other embodiments the sweetener composition may have a concentration of at least 200 ppm to 2900 ppm.

The sweetener composition of the present disclosure includes at least one natural sweetener. In additional embodiments the sweetener composition can include more than one natural sweetener, to create a natural combination sweetener. The natural sweetener as used herein can be any natural sweetener composition used in food and beverage compositions. In one embodiment the natural sweetener is Stevia. The Stevia composition can be any form of a Stevia sweetener composition used as a sweetener in food and beverage compositions. A Stevia sweetener is a natural sweetener made from the extracts of the stevia plant leaf. Additionally, stevia sweeteners can also be made through fermentation using specially crafted yeast to produces stevia glycosides. The stevia flycosides that can be used include but are not limited to Steviol, Stevioside, RebM, RebD, REbC, Dulcoside A RebE, Steviolbioside, Rubusoside and combinations thereof. In additional embodiments the natural sweetener composition can be any nonnutritive natural sweetener known in the art this can include but is not limited to monk fruit extract. The natural sweetener may have a concentration in the sweetener composition of about 3.23% to about 4.19%. Additionally, the concentration of the natural sweetener in the beverage composition is from about 0.0006% to about 0.012%. In some examples the natural sweetener is from about 0.001%, 0.002%, 0.003%, 0.004%, 0.005%, 0.006%, 0.007%, 0.008%, 0.009%, 0.010%, 0.011% or about 0.012% of the food or beverage composition. In some further examples, the natural sweetener is 0.0006%, 0.0007%, 0.0008%, 0.0009%, 0.001%, 0.002%, 0.003%, 0.004%, 0.005%, 0.006%, 0.007%, 0.008%, 0.009%, 0.010%, 0.011%, 0.012% 0.0013%, 0.0014%, 0.0015%, 0.0016%, 0.0017%, 0.0018%, 0.0019% 0.0020%, 0.0021 % to about 0.0022% of the food or beverage composition.

The sweetener composition of the present disclosure includes at least one artificial sweetener. In additional embodiments the sweetener composition can include more than one artificial sweetener, to create an artificial combination sweetener. The artificial sweetener as used herein can be any artificial sweetener composition used as a sweetener in food and beverage compositions. In one embodiment the artificial sweetener is sucralose. In additional embodiments the artificial sweetener composition can be any artificial sweetener known in the art this can include but is not limited to aspartame (Equal and NutraSweet), Neotame, sucralose (Splenda), saccharin (Sweet′N Low) and its sodium ammonium and calcium salts, Advantame, and combinations thereof. The sucralose may have a concentration in the sweetener composition of about 8.55% to about 32.26%. The artificial sweetener may have a concentration in the beverage composition of about 0.006% to about 0.0246%. In some examples the artificial sweetener is 0.006%, 0.007%, 0.008%, 0.009%, 0.010%, 0.011 %, 0.012% 0.013%, 0.014%, to about 0.015%, of the food or beverage composition. In another embodiment, the artificial sweetener is 0.001 %, 0.002%, 0.003%, 0.004%, 0.005%, 0.006%, 0.007%, 0.008%, 0.009%, 0.010%, 0.011 %, 0.012%, 0.013%, 0.014%, 0.015%, 0.016%, 0.017%, 0.018%, 0.019%, 0.020%, 0.021 %, 0.022%, 0.023%, 0.024%, to about 0.025% of the food or beverage composition.

The sweetener composition and resultant beverage or food compositions will not include an amount of acesulfame potassium, which is a known artificial sweetener also known as acesulfame K or Ace K.

The sweetener composition further includes an amount of a mask agent. The mask agent is an ingredient used to bind to taste receptors to minimize off-note tastes and therefore blocks off-note perception from sweeteners and sweetener compositions. The mask agent has been found to work in conjunction with the current sweeteners to create the desirable sweetener composition with the improved taste, flavor, and temporal profile. The mask agent can include honey, maltitol and isomalt, mushroom extract, gum acacia, molasses, glutami acid (glutamates), and polyols such as erthitol and combinations thereof. The mask agent may have a concentration in the sweetener composition of 5.38% to about 17.45%. Additionally, the mask agent may have a concentration in the beverage composition of about 0.001 % to .05% of the food or beverage composition. In non-limiting examples the mask agent in the food or beverage composition 0.001 %, 0.002%, 0.003%, 0.004%, 0.005%, 0.006%, 0.007%, 0.008%, 0.009%, 0.010%, 0.011%, 0.012%, 0.013%, 0.014%, 0.015%, 0.016%, 0.017%, 0.018%, 0.019%, 0.020%, 0.021%, 0.022%, 0.023%, 0.024%, 0.025%, 0.026%, 0.027%, 0.028%, 0.029%, 0.030%, 0.031%, 0.032%, 0.033%, 0.034%, 0.035%, 0.036%, 0.037%, 0.038%, 0.039%, 0.040%, 0.041%, 0.042%, 0.043%, 0.044%, 0.045%, 0.046%, 0.047%, 0.048%, 0.049%, to about 0.050%.

The sweetener composition further includes an amount of a protein binder composition. The protein binder ingredient competes with flavor molecules for binding to the active binding sites on the protein. By binding to the active sites on the protein this allows for more availability of flavor molecules to therefore increase the flavor perception and profile for a consumer. The desired protein binders are specially formulated FEMA GRAS chemicals that are found in different molecular weights to allow for the absorption and binding on the protein. The protein binders will be low molecular weight, medium molecular weight, and high molecular weight. The protein binders can include chemical groups that include but are not limited to aldehydes, ketones, alcohols, and pyrazine as well as combinations thereof. The protein binder may have a concentration in the sweetener composition of 34.90% to about 53.76%. Additionally, the protein binder may have a concentration in the beverage composition of about 0.01 % to 0.1% for the food or beverage composition. In non-limiting examples the protein binder in the food or beverage composition is 0.01 %, 0.02%, 0.03%, 0.04%, 0.05%, 0.06%, 0.07%, 0.08%, 0.09%, to about 0.10%.

The sweetener composition further includes an amount of a mouthfeel enhancer. The mouthfeel enhancer reduces the friction force in the mouth of the user, which improves the overall texture or temporal profile for the consumer by creating an improved creamy mouthfeel. The mouthfeel enhancer can be maltodextrin or modified corn starch. The mouthfeel enhancer may have a concentration in the sweetener composition of 5.38% to about 34.90%. Additionally, the mouthfeel modulator may have a concentration in the beverage composition of about 0.001 % to 0.1% for the food or beverage composition. In non-limiting examples the mouthfeel enhancer in the food or beverage composition is 0.001 %, 0.002%, 0.003%, 0.004%, 0.005%, 0.006%, 0.007%, 0.008%, 0.009%, 0.010%, 0.015%, 0.02%, 0.025%, 0.03%, 0.035%, 0.04%, 0.045%, 0.05%, 0.055%, 0.06%, 0.065%, 0.07%, 0.075%, 0.08%, 0.085%, 0.09%, 0.095%, to about 0.10%.

### II. Protein Shake

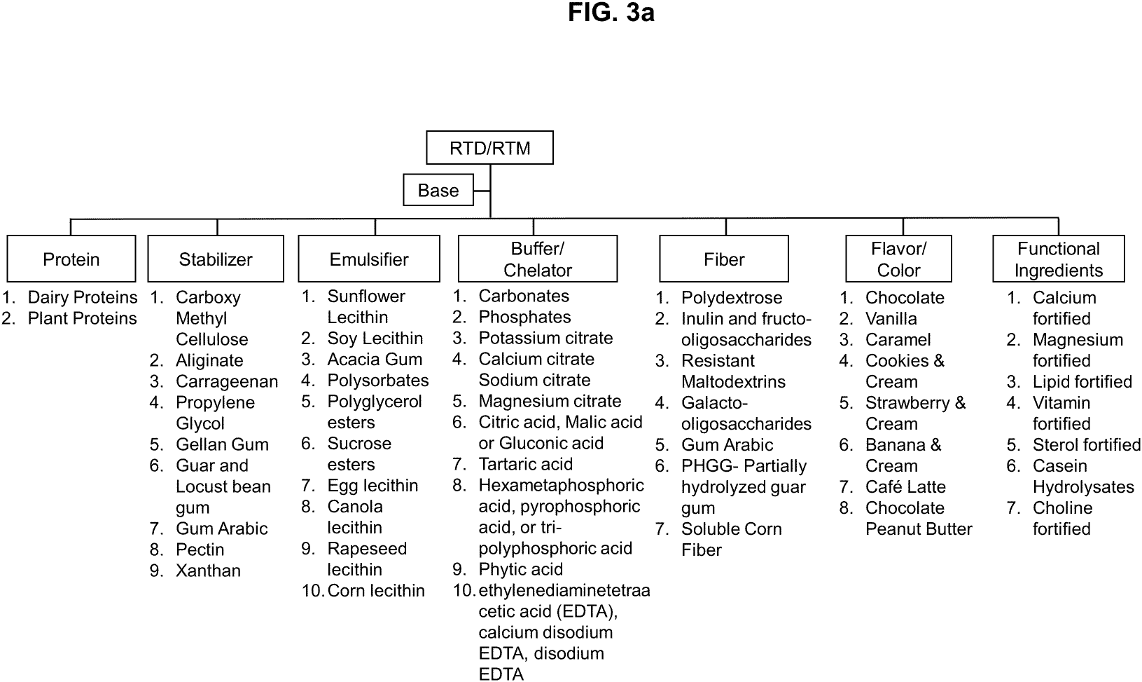

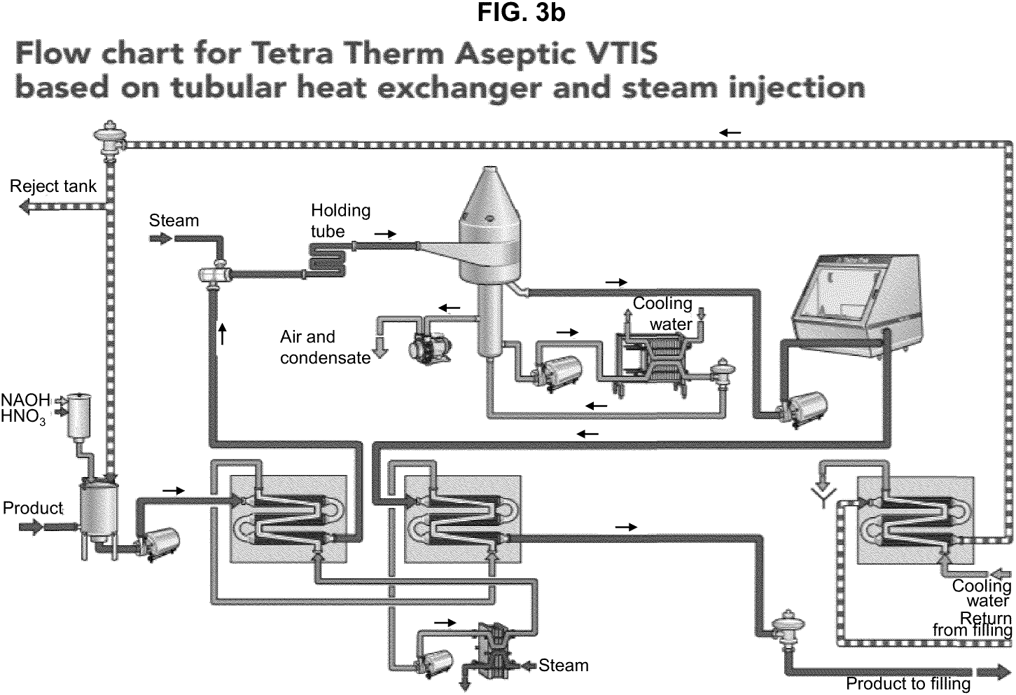

Also disclosed here is a protein shake comprising the sweetener composition described in Section I above. The protein shake may further include a protein, stabilizer composition, flavoring agents, coloring agents, micronutrients, preservatives, antifoaming agents, and other ingredients known by those skilled in the art. As shown in FIG. 3, the RTD (ready-to-drink) and RTM (ready-to-mix) compositions may include a protein, stabilizer, emulsifier, buffer, fiber, flavoring agents, coloring agents, micronutrients, preservatives, antifoaming agents, and other functional ingredients known to those skilled in the art and may be prepared using the general overview shown in example 1.

The protein shake of the present disclosure could be an RTD (ready-to-drink) or an RTM (ready-to-mix) composition. In some embodiment, the protein may be a dairy protein, a plant protein, or any combination thereof. In some aspects, the protein is a milk protein that may include milk protein concentrate, milk protein hydrolysate, milk protein isolate, whey, or casein. In some additional aspects, the protein may be any plant protein that may include globulins, albumins, glutelins, or prolamins. In some additional aspects the protein may be derived by fermentation processes or via cell cultures.

In some embodiments, the amount of protein in an 8-ounce shake may be from about 5 g to about 35 g for a ready-to-drink (RTD) composition and about 5 g to 20 g of protein for a serving size of about 10 g to 35 g ready-to-mix (RTM)). In some examples, the amount of protein in an 8-ounce shake may be about 5 g, 10 g, 15 g, 20 g, 25 g, 30 g, or about 35 g. In some further examples, the amount of protein in an 8-ounce shake may vary between 5 g to 10 g, about 10 g to about 15 g, about 15 g to about 20 g, about 20 g to about 25 g, about 25 g to about 30 g, or about 30 g to about 35 g. In additional embodiments the amount of protein in a protein shake or in the powder mix to then create the beverage shake end product will be between 1 g and 60 g of protein per serving size, with the serving size of the protein shake being from 5 g to 400 g. Additionally, the amount of protein included in a shake product can be between 0.333 g and about 4.375 g of protein per ounce of a shake product. The desired amount of protein in the shake product either in the form of an RTD or RTM shake product will depend on the desired amount of protein to provide per serving size for a consumer.

The protein shake of the present disclosure includes at least one food additive. In some embodiments, the food additive may be one or more of a flavoring agent, a coloring agent, a pH adjusting agent, an antifoaming agent, sweeteners, salt, water, micronutrients or functional ingredients, fiber, or any other food additive known to those skilled in the art and any combination thereof.

The protein shake of the present disclosure may include flavoring agents. In some embodiments, the flavoring agents may include natural flavors, artificial flavors, or other flavoring agents known to those skilled in the art and any combination thereof. In some examples, flavoring agents include vanilla flavoring agents, caramel flavoring agents, chocolate flavoring agents, cocoa particles or ingredients, and other flavoring agents known to those skilled in the art. In some aspects, the flavoring agents may have a concentration in the shake varying from 0.05% to 0.5%.

The protein shake of the present disclosure may include an excellent source of fiber. In some embodiments, the fiber source may include inulin, fructo-oligosccharides, resistant maltodextrins, galacto-oligosaccharides, gum arabic, PHGG- Partially hydrolyzed guar gum, soluble corn fiber, or any other fiber sources known to those skilled in the art. In some aspects, the fiber sources may have a concentration ranging from 1.4% to 7.5% to make an excellent source of fiber claim.

The protein shake of the present disclosure may include one or more pH adjusting agents. In some embodiments, the pH adjusting agent may include potassium hydroxide, sodium hydroxide, calcium hydroxide, acetic acid, citric acid or combinations thereof. The pH adjusting agent may be added as needed to achieve a predetermined desired pH.

The protein shake of the present disclosure may include an antifoaming agent. In some embodiments, the antifoaming agent may include insoluble oils, polydimethylsiloxane, or other antifoaming agents known to those skilled in the art. In some aspects, the antifoaming agent may have a concentration of about 0.01 %.

The protein shake of the present disclosure may include one or more sweeteners, in addition to the sweetener composition from Section 1. In some embodiments, the sweetener may be natural or artificial. In some aspects, the sweetener may include cane sugar, sucralose, acesulfame potassium, monk fruit, stevia or other sweeteners known in the art and any combination thereof. In some aspects, the concentration of the sweetener in the protein shake may vary from 0.001 % to 0.04%

The protein shake of the present disclosure may include one or more fibers. In some embodiments, the fiber may include soluble corn fiber, galatooligosaccharides, fructo-oligosaccharides etc. In some aspects, the fiber may have a concentration in the protein shake varying from 0.5% to 5%.

The protein shake of the present disclosure may include micronutrients and/or functional ingredients. In some embodiments, the micronutrients may include vitamin A, vitamin E, vitamin D, vitamin K, vitamin B6, folate, zinc, vitamin C, magnesium, calcium, choline, hydrolyzed milk protein, or any other micronutrient or functional ingredient and any combination thereof.

### III. Production Method for the Protein Shake

Also, disclosed is a method for producing a protein shake, and in particular a ready-to-drink (RTD) protein shake comprising the sweetener composition described in Section I above. The protein shake includes numerous other ingredients including but not limited to protein composition, flavoring agents, coloring agents, micronutrients, preservatives, antifoaming agents, and other ingredients known by those skilled in the industry. In one embodiment the RTD shake is prepared based on current industry methods for forming a RTD protein shake. FIGS. 3a and 3b provides an overview of ingredients an example of the typical industry methods for the creation of the RTD protein shake.

The production operation can be divided into four steps: pre-sterilization, production, aseptic intermediate cleaning (AIC) and cleaning in place (CIP) as shown in FIG. 3b. The initial step is to prepare the tank or holding/filing machine to add the ingredients for the desired product. The ingredients are then added to the mixing tank and regeneratively pre-heated to about 80° C. (application dependent) in a Tetra Pak® Tubular Heat Exchanger or, as an alternative, in a Tetra Pak® Plate Heat Exchanger. Addition of the ingredients ensures instant heating of the ingredients to sterilization temperature through means of a steam injector by continuous injection of high -pressure steam into the mixture. The mixture then enters a holding tube where it is held at a sterilization temperature for the required time period as defined by production method to ensure proper parameters are met for the production and later packaging of the mixture/product. The mixture then enters the flash vessel where the pressure and temperature drop instantly to aide in product stability and lead up to packaging. The excess water in the form of steam is flashed off and released to not impair the desired product. For optimal product stability, the mixture passes through an aseptic homogenizer before final cooling in the heat exchanger. To aide in continual product production aseptic intermediate cleaning (AIC) can be performed to prolong the production time between full CIPs. When AIC is selected, the mixture creates the product and is displaced by sterile water before cleaning starts. During the AIC sequences, the holding tube is kept at the sterilization temperature, thus keeping the aseptic parts of the unit sterile. After each production run, the unit undergoes cleaning to ensure future batch production is ready.

### EXAMPLES

### Example 1 : Preparation of the Protein Shakes

Protein shakes (ready to drink shakes - RTD) were prepared based on current industry methods for forming a ready to drink protein shake. FIG. 3b provides an overview of an example of the industry methods for the creation of the protein shake.

Following the industry methods, a protein shake composition (shake Example 1) was created with the following compositions:

TABLE 1

Examples of the ingredient list for 12 g protein and 30 g protein RTD (ready-to-drink) prototypes/examples with great taste, mouthfeel, texture and robust rheology profiles

| | |
|---|---|
| | Ingredient Statement |
| 12 g Protein shake Protype | INGREDIENTS: Water, Milk Protein Concentrate, Soluble Corn Fiber, Contains less than 2% of t, GOS Galacto-Oligosaccharide, cocoa powder (processed with alkali), High Oleic Sunflower Oil, Cellulose gel and cellulose gum, Sucralose Magnesium Phosphate, Sunflower Lecithin, Salt, Tripotassium Citrate, Sodium Ascorbate (Vit C), Choline Chloride, |
| | Vitamin and Mineral Blend (dl-alpha tocopheryl acetate [vitamin E], zinc glycinate chelate, pyridoxine hydrochloride [vitamin B6], vitamin A palmitate, folic acid, phytonadione [Vitamin K1], cholecalciferol [vitamin D3]), Potassium Hydroxide, Carrageenan, Stevia Sweetener, Antifoam. |
| 30 g protein shake Prototype | INGREDIENTS: Water, Milk Protein Concentrate, Calcium Caseinate, cocoa powder (processed with alkali), High Oleic Sunflower Oil, Cellulose gel and cellulose gum, Salt, Sucralose, Magnesium Phosphate, tripotassium phospate, dipotassium phosphate, sodium hexametaphosphate, Sodium Ascorbate (Vit C), Natural and Artificial Flavors, |
| | Vitamin and Mineral Blend (DL-alpha tocopheryl acetate [vitamin E], zinc glycinate chelate, ferric orthophosphate, vitamin A palmitate, niacinamide, phytonadione [vitamin K1], potassium iodide, cholecalciferol [vitamin D3], copper gluconate, calcium D-pantothenate, manganese sulfate, sodium selenite, biotin, sodium molybdate, folic acid, thiamine mononitrate [Vitamin B1], cyanocobalamin [vitamin B12], pyridoxine hydrochloride [vitamin B6], riboflavin, [vitamin B2], chromium polynicotinate), Carrageenan, Stevia Sweetener, Antifoam, Magrabar, Inulin, Potassium Hydroxide |

### Example 2: Rheological Overview

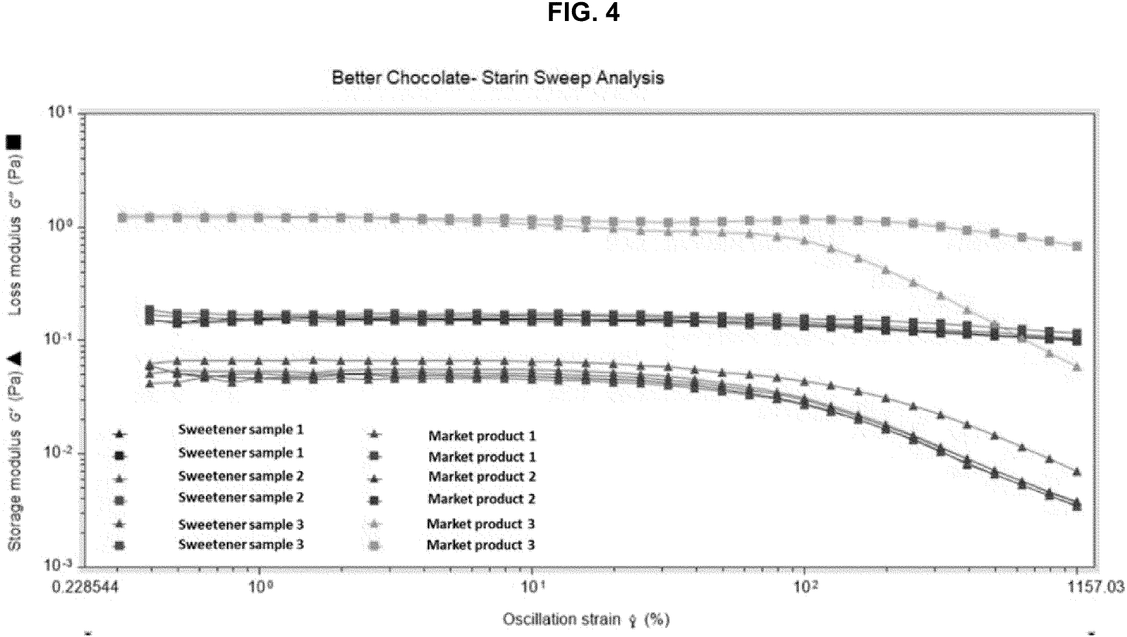

Rheological testing was conducted on the novel protein shake compositions from Example 1 and compared to current market products. The novel protein shake compositions exhibit rheological properties that are not disrupted by the use of the sweetener composition used to create the desired beverage. (see FIG. 4)

### Example 3: Sensory Testing

Sensory testing was conducted on the novel protein shake compositions from Example 1 and compared to current market products. The sensory testing focused on the sensory taste experiences, as outlined in the parameters below, that include mouthfeel and flavor and the consumers response to the shake composition.

Sensory Testing Parameters:
Overall liking data were collected by asking consumers to describe their overall opinion of the product using a 9-pt liking scale.
Overall aroma liking data were collected by asking consumers to describe their overall opinion of the product using a 9-pt liking scale.
Overall flavor liking data were collected by asking consumers to describe their overall opinion of the product’s flavor using a 9-pt liking scale.
Overall mouthfeel liking data were collected by asking consumers to describe their overall opinion of product’s mouthfeel using a 9-pt liking scale.
Overall sweetness data were collected by asking consumers to describe their overall opinion of the product using a 9-pt liking scale.

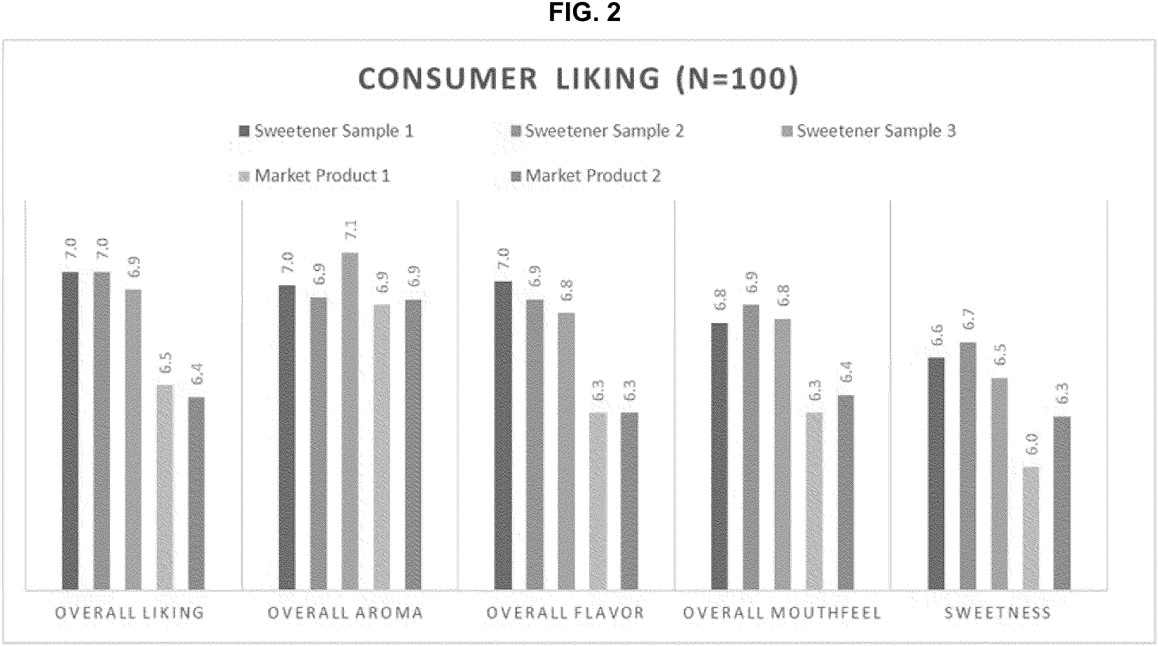

Sensory testing was conducted on the 12 g novel protein shake sweetener compositions and compared to current market products. The sensory testing focused on the sensory taste experiences (taste and temporal profile), as outlined in the parameters below, that include overall liking, sweetness liking, and overall texture liking. Based on a large-scale dairy protein shake consumer central location study conducted in 2021 (n=156), our new sweetener systems were well liked with a consumer liking score from 6.8 to 7.2 in a 9-point liking scale. They have shown significantly superior taste when compared to leading market protein shakes. (see FIGS. 1 and 2)

Sensory testing was conducted on the novel 30 g protein shake sweetener compositions and compared to current market products. The sensory testing focused on the sensory taste experiences (taste and temporal profile), as outlined in the parameters below, that include overall liking, sweetness liking, and overall texture liking. Based on a large-scale dairy protein shake consumer central location study conducted in 2021 (n=100), our new sweetener systems were well liked with a consumer liking score from 6.7 to 7.2 in a 9-point liking scale. They have shown significantly superior taste when compared to leading market protein shakes.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

Having described several embodiments, it will be recognized by those skilled in the art that various modifications, alternative constructions, and equivalents may be used without departing from the spirit of the invention. Additionally, a number of well-known processes and elements have not been described in order to avoid unnecessarily obscuring the present invention. Accordingly, the above description should not be taken as limiting the scope of the invention.

Those skilled in the art will appreciate that the presently disclosed embodiments teach by way of example and not by limitation. Therefore, the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall there between.

What is claimed is:

1. A protein shake composition comprising:
a protein; and
a sweetener composition, wherein the sweetener composition comprises:
a natural sweetener;
an artificial sweetener;
a mask agent;
a protein binder; and
a mouthfeel modulator.

2. The composition of either of claims 1, wherein the natural sweetener is stevia sweetener.

3. The composition of claim 1, wherein the natural sweetener has a concentration of about 0.0006% to about 0.012%.

4. The composition of claims 1, wherein the artificial sweetener is selected from the group consisting of sucralose, aspartame, neotame, saccharin, advantame, and combinations thereof.

5. The composition of claim 1 wherein the artificial sweetener has a concentration of about 0.006% to about 0.0246%.

6. The composition of claims 1, wherein the mask agent is selected from the group consisting of honey, maltitol and isomalt, mushroom extract, gum acacia, molasses, glutami acid (glutamates), and polyols such as erthitol and any combination thereof.

7. The composition of claim 1, wherein the mask agent has a concentration of about 0.001 % to about 0.05%.

8. The composition of claims 1, wherein the protein binder has chemical groups that include but are not limited to aldehydes, ketones, alcohols, and pyrazine as well as combinations thereof.

9. The composition of claim 1, wherein the protein binder has a concentration of about 0.01% to about 0.1%.

10. The composition of claims 1, wherein the mouthfeel modulator is selected from the group consisting of maltodextrin, modified corn starch and any combination thereof.

11. The composition of claim 1, wherein the mouthfeel modulator has a concentration of about 0.001% to about 0.1%.

12. The composition of claim 1, wherein the protein shake composition is a ready to drink shake composition.

13. The composition of claim 1, wherein the protein shake composition does not include acesulfame potassium.

14. A ready to mix protein shake powder composition comprising:
a protein; and
a sweetener composition, wherein the sweetener composition comprises:
a natural sweetener;
an artificial sweetener;
a mask agent;
a protein binder;
a mouthfeel modulator, and
at least one food additive.

15. A sweetener composition comprising:
a natural sweetener;
an artificial sweetener;
a mask agent;
a protein binder; and
a mouthfeel modulator.

16. The composition of claim 15, wherein the natural sweetener is stevia sweetener and has a concentration of about 3.23% to about 4.19%.

17. The composition of claim 15, wherein the artificial sweetener is selected from the group consisting of sucralose, aspartame, neotame, saccharin, advantame, and combinations thereof and has a concentration of about 8.55% to about 32.26%.

18. The composition of claim 15, wherein the mask agent is selected from the group consisting of honey, maltitol and isomalt, mushroom extract, gum acacia, molasses, glutami acid (glutamates), and polyols such as erthitol and any combination thereof and has a concentration of about 5.38% to about 17.45%.

19. The composition of claim 15, wherein the protein binder has chemical groups that include but are not limited to aldehydes, ketones, alcohols, and pyrazine as well as combinations thereof and has a concentration of about 34.9% to about 53.76%.

20. The composition of claim 15, wherein the mouthfeel modulator is selected from the group consisting of maltodextrin, modified corn starch and any combination thereof and has a concentration of about 5.38% to about 34.90%.

21. The composition of claim 15, wherein the sweetener composition does not include acesulfame potassium.
